(19) United States
(12) Patent Application Publication
(10) Pub. No.: US 2015/0379122 A1
(43) Pub. Date: Dec. 31, 2015

(54) METHOD AND APPARATUS FOR ELECTRONIC CONTENT REPLACEMENT BASED ON RATING

(71) Applicant: THOMSON LICENSING, Issy de Moulineaux (FR)

(72) Inventor: John James Fitzpatrick, Indianapolis, IN (US)

(21) Appl. No.: 14/714,606

(22) Filed: May 18, 2015

Related U.S. Application Data
(60) Provisional application No. 62/018,015, filed on Jun. 27, 2014.

(51) Int. Cl. G06F 17/30; H04L 29/08; G06F 17/24

(52) U.S. Cl. CPC G06F 17/30707; G06F 17/24; G06F 17/30684; G06F 17/30011; H04L 67/10; H04L 67/02

(57) ABSTRACT

The present principles of the embodiments generally relate to an apparatus and a method for processing and/or displaying of electronic book and/or web media content. In one exemplary embodiment, the present invention is able to process text of an electronic book or a web page and replaces any word or phrase in the electronic media dynamically based on a selected rating level of an electronic device, such e.g., an electronic reader, cell phone or a tablet. In another exemplary embodiment, the words or phrases associated with a selected rating level and the associated lists of their replacements may be modifiable by a user, so customized lists of terms may be used with different user rating levels.

### BACKGROUND OF THE INVENTION

1. Field of the Invention

The present principles of the embodiments generally relate to an apparatus and a method for processing and/or displaying electronic book and/or web media content. In one exemplary embodiment, the present invention is able to process text of an electronic book or a web page and replaces any word or phrase in the electronic media dynamically based on a selected rating level of an electronic device, such as an electronic reader, a cell phone or a tablet. In another exemplary embodiment, the words or phrases associated with a selected rating level and the associated lists of their replacements may be modifiable by a user, so customized lists of terms may be used with different user rating levels.

2. Background Information

Various parental guide systems have been proposed for electronic devices, such as television receivers. In U.S. Pat. No. 8,117,282, issued to Jarman et al., a media player is disclosed which is configured to allow filtered playback of a movie. In order for the Jarman system to work, however, filtered contents have to be constructed and identified separately, and are typically manually produced at some point after the movies have been released. Therefore, the system does not work with regular movie contents.

U.S. Pat. No. 7,139,031, issued to Bray, is another system for use with television receivers as well. The Bray system is proposed for replacing an offensive word or a phrase in the Closed Caption data of a television receiver with an acceptable word or phrase. A user of the Bray system, however, is not able to customize the lists of the words or phrases being searched and/or the associated lists of their replacements. The system is also not used for electronic book, article or web page contents.

In addition, as electronic readers (or e-readers) have become more ubiquitous, electronic text replacement schemes for e-readers have been proposed. For example, U.S. Pat. No. 8,365,059, issued to Walsh et al., discloses an e-reader capable of changing the textual length of an electronic text while maintaining the meaning of the electronic text content. The Walsh system, however, is unrelated to any text replacement based on ratings.

In another example, US Patent Application Publication US20120331517 A1, filed by Wilcox, discloses an electronic reader in which an obscene content is flagged or replaced with a less obscene content. However, a user of the Wilcox system is also not able to customize the lists of the words or phrases being searched and/or the associated lists of their replacements. In addition, the Wilcox system seems to generate a content rating of an electronic file only after the electronic book content has been modified, and therefore, the content rating disclosed seems not to be related to the electronic device and not selected by the user for the electronic device.

### SUMMARY OF THE INVENTION

The present inventors recognize the needs to improve the existing systems and methods for processing electronic contents such as, e.g., text in an electronic book and web page content according to different rating levels selected for an electronic device, such as, e.g., an electronic reader, a cell phone, a tablet, a PC, and etc.

In accordance with an aspect of the present invention, an apparatus is presented, comprising:

an interface for receiving a first user input for selecting a first rating level of a plurality of rating levels associated with an electronic device;

a processor operative or configured to process a first file containing a plurality of words by searching for a first term in the first file according to a first list of words, the first list of words associated with the selected first rating level, wherein the first list of words is modifiable by a user, the processor is operative or configured to replace the first term in the first file with a second term found in searching a second list of words to form a modified first file, the second term is associated with the first term, and the second list of words is associated with the selected first rating level, and; and

a display for displaying the modified first file.

In another exemplary embodiment, a method is presented comprising:

receiving a first user input for selecting a first rating level of a plurality of rating levels associated with an electronic device;

processing a first file containing a plurality of words by searching for a first term in the first file according to a first list of words, the first list of words associated with the selected first rating level, the first list of words being modifiable by a user;

replacing the first term in the first file with a second term found in searching a second list of words to form a modified first file, the second term associated with the first term, wherein the second list of words is associated with the selected first rating level; and

displaying the modified first file.

In accordance with principles of the present invention, a computer program product stored in a non-transitory computer-readable storage media is presented, comprising computer-executable instructions for:

receiving a first user input for selecting a first rating level of a plurality of rating levels associated with an electronic device;

processing a first file containing a plurality of words by searching for a first term in the first file according to a first list of words, the first list of words associated with the selected first rating level, the first list of words being modifiable by a user;

replacing the first term in the first file with a second term found in searching a second list of words to form a modified first file, the second term associated with the first term, wherein the second list of words is associated with the selected first rating level; and

displaying the modified first file.

In accordance with another aspect of the present invention, an apparatus is presented, comprising:

interface means for receiving a first user input for selecting a first rating level of a plurality of rating levels associated with an electronic device;

processing means operative or configured to process a first file containing a plurality of words by searching for a first term in the first file according to a first list of words, the first list of words associated with the selected first rating level, wherein the first list of words is modifiable by a user, the processing means is operative or configured to replace the first term in the first file with a second term found in searching a second list of words to form a modified first file, the second term is associated with the first term, and the second list of words is associated with the selected first rating level, and; and

a display for displaying the modified first file.

In one embodiment, the second list of words is modifiable by the user.

In another embodiment, the first term and the second term comprise a word or a phase containing more than one word. The second term may also contain a blank or not present indicating no corresponding second term.

In another embodiment, the corresponding second term is selected based on usage context of the first term in the first file. For example, based on the usage of the first term in the first file, even if there is a corresponding second term in the second list, the first term in the first file is not replaced, masked, or blocked.

In another embodiment, the first term is not replaced by the second term, if the user enters a correct password.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

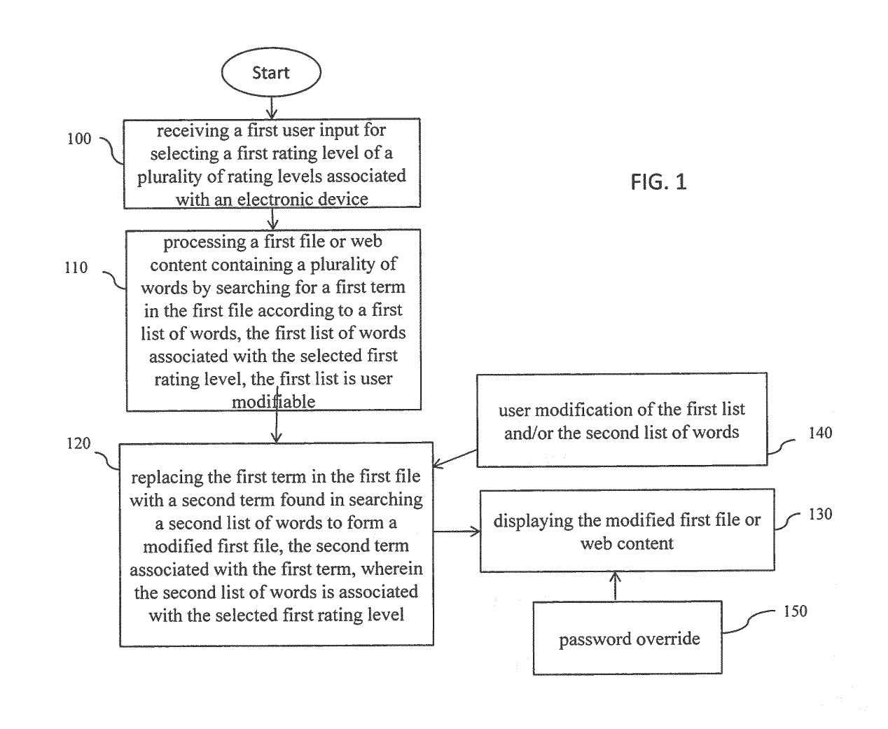

FIG. 1 shows an exemplary process according to the principles of the present invention;

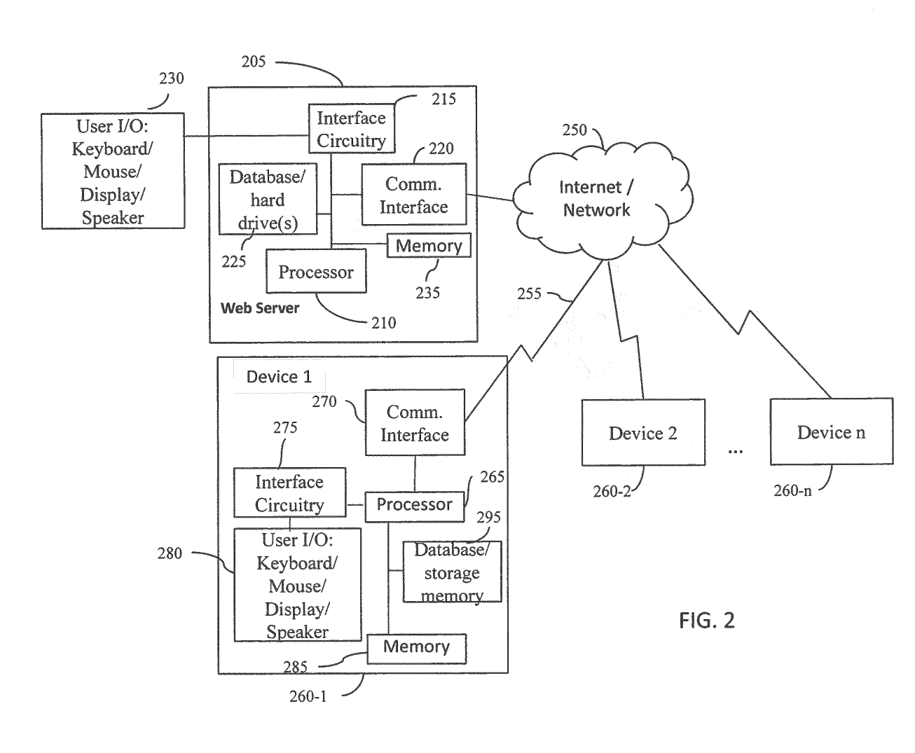

FIG. 2 shows an example system according to the principles of the present invention;

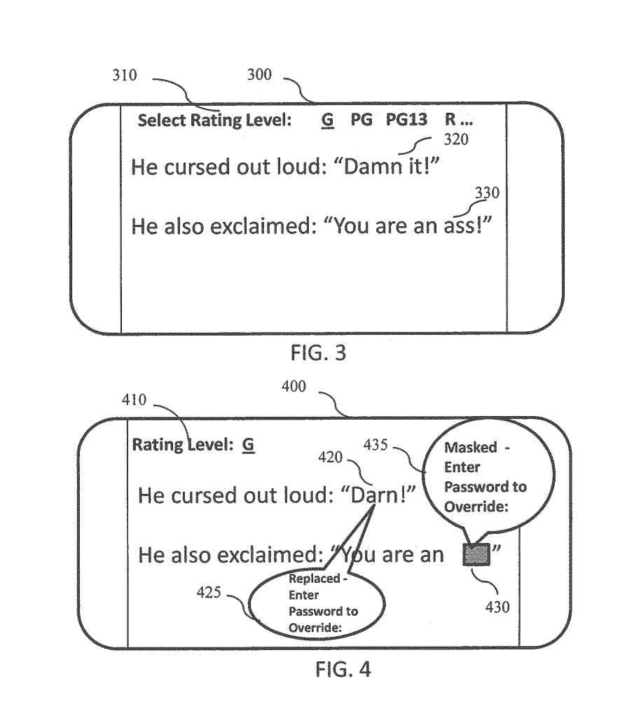

FIG. 3 to FIG. 6 show exemplary user interfaces, display screens and related functions of an exemplary electronic device according to the principles of the present invention.

The examples set out herein illustrate exemplary embodiments of the invention. Such examples are not to be construed as limiting the scope of the invention in any manner.

### DETAILED DESCRIPTION

Referring now to the drawings, FIG. 2 is an exemplary system according to the principles of the present invention. FIG. 2 is a diagram representing, for example, a system capable of providing different media content, such as electronic books or articles, web pages and, streaming media, and etc. For example, various user devices 260-1 to 260-n in FIG. 2 may access a media asset over the internet 250. The media service or video service is hosted, for example, by a web server 205. Web server 205 may be a server having a processor 210 such as an Intel processor, running an appropriate operating system such as, Windows 2008 R2, Windows Server 2012, Linux operating system, etc. Devices 260-1 to 260-n may access the different media contents provided by server 205 using, for example, a streaming protocol such as e.g., Apple HTTP Live Streaming (HLS) protocol, Adobe Real-Time Messaging Protocol (RTMP), Microsoft Silverlight Smooth Streaming Transport Protocol, and etc., or a downloading protocol such as e.g., HTTP, FTP, and etc.

In addition, a web server administrator may interact with server 205 using various user I/O devices 230 such as, e.g., a keyboard, a display (with or without touch recognition), and speaker, etc., as well known in the art. Media assets and their associated metadata (e.g., media content guide and related information) may be stored in a database 225 and accessed by processor 210 in server 205 as needed. Database 225 may reside in appropriate storage media, such as, one or more hard drives. Server 205 is connected to, for example the internet or a local or wide area network 250 through a communication interface 220, to be connected to one or more of user devices 260-1 to 260-n. In addition, one skilled in the art would readily recognize that other server components, such as, e.g., RAM memory 235, and etc., may also be needed.

User devices 260-1 to 260-n may be, for example, a PC, laptop, tablet, cellphone, e-reader and etc. Such a user device may also be, for example, a Microsoft Windows 7 or Windows 8 computer, an Android phone (e.g., Samsung S3, S4, or S5), an Apple IOS phone (e.g., IPhone 5S or 5C), Apple IPad, Amazon Kindles, and etc. A detailed block diagram of an exemplary user device according to the principles of the present invention is illustrated in block 260-1 of FIG. 2.

Exemplary device 260-1 comprises a processing means such as a processor 265 operative or configured to process various data and to control various functions and components of the device 260-1. The processor 265 is also operative or configured to execute software/firmware code for implementing embodiments of the principles of the invention in addition other code for the operation of the device 260-1. The processor 265 can be a microprocessor or a microcontroller. A user interface means such as a user interface circuit 275 interfaces with the various user I/O components 280 (which may include, for example, a virtual touch or physical keyboard, a display (with or without touch recognition), a speaker, and etc.) for inputting and/or outputting user data. Device 260-1 also comprises a RAM memory 285 for processing and storing different information as necessary. Device 260-1 also comprises communication interface 270 for connecting and communicating to/from web server 205 via, e.g., the internet 250, using for example, a cable network, a FIOS network, a Wi-Fi network, and/or a cellphone network such as, e.g., 3G, 4G, LTE, and etc. In additional, a database residing in non-volatile, non-transitory memory 295 may store contents from webserver 205 or other information (e.g., lists of words to be described later) as necessary. Storage memory 295 also store software/firmware code mentioned above. Storage memory 295 may also represent a local memory medium such as, e.g., a memory card, a USB stick, and etc.

FIG. 3 to FIG. 6 illustrate exemplary user interface screens and functions according to the principles of the present invention. These user interface screens and functions may be controlled and/or provided by for example, processor 265 in device 260-1 and/or processor 210 in web server 205 of FIG. 2.

FIG. 1 is a flow chart of an exemplary process according to principles of the present invention. In one embodiment, the exemplary process may be implemented as computer executable instructions represented by software/firmware code stored in storage memory 295 and/or 225, which may be executed by, e.g., processor 265 in device 260-1 and/or processor 210 in web server 205 of FIG. 2. For example, a computer program product having the computer-executable instructions may be stored in non-transitory computer-readable storage media (e.g., storage memory 295 and/or 225) of the respective devices 260-1 and/or 210. The exemplary process shown in FIG. 1, when executed, facilitates processing and displaying of user interfaces shown, for example, in FIG. 3 to FIG. 6, and controlling of their respective functions and interactions with a user. One skilled in the art can readily recognize that the exemplary process shown in FIG. 1 may also be implemented in hardware (e.g., logic arrays or ASIC), and/or a combination of hardware and software (e.g., a firmware implementation). In the following illustration, the process is executed by the processor 265 in device 260-1.

At step 100, device 260-1 is operative or configured to receive a first user input for selecting a first rating level (e.g., 310 of FIG. 3) of a plurality of rating levels associated with the electronic device. A user may specify the level 310 by using, for example, one or more of the user I/O devices 280 in FIG. 3, as well known in the art. In one exemplary embodiment, the rating levels could be similar to and based on that of Motion Picture Association of American (MPAA) movie ratings (e.g., G, PG, PG-13, R, and etc.) In another embodiment, the ratings could be based on FCC television rating systems in U.S. of six ratings categories (e.g., TV-Y, TV-Y7, TV-G, TV-PG, TV-14 or TV-MA). In yet another embodiment, different customizable categories/rating levels may be created such as, for example, a religious Christian category which would block terms that a religious Christian person may find offensive, a non-obscenity category which would block terms which may be considered as obscene, and etc.

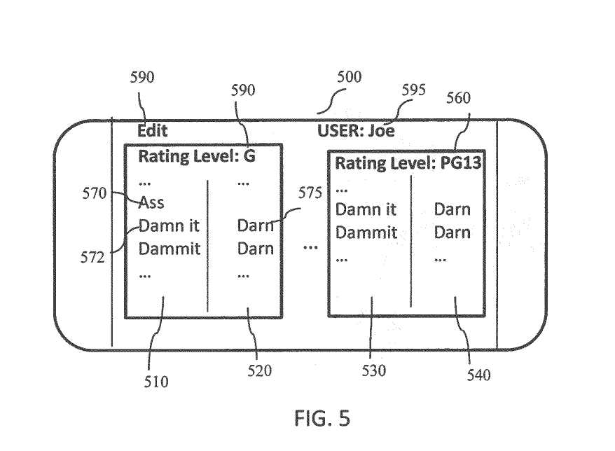

At step 110, device 260-1 is operative or configured to process a first file containing a plurality of words by searching for a first term in the first file according to a first list of words, the first list of words associated with the selected first rating level. The first file or content is obtained, for example, from a web server 205 remotely or a memory medium 295 locally. As noted before, the first file or content may represent an e-book, an e-article, web page content, and etc., containing a plurality of words. In addition, for each rating level selected for device 260-1, a default and pre-generated list of words or phrases obtained, for example, from a conventional system, is provided. The first list of words represents a list of words or phrases to be blocked, masked or replaced. The first list is associated with the selected first rating level. For example, as shown in FIG. 5, if a rating level G has been selected for device 500 of FIG. 5, an associated default list 510 is accessed and used. On the other hand, if a rating level PG 13 has been selected for device 500 of FIG. 5 instead, an associated default list 530 is accessed and used instead. One skilled in the art would appreciate that It would be logical that a less restrictive rating (e.g., PG13) will most likely to contain fewer number of default words or phrases to be blocked, masked or replaced than a more restrictive rating (e.g., G). As discussed later, in one embodiment, the first list is modifiable by a user.

The first term is one of the words in the first list and the processing step searches the first file for an occurrence of the first term.

At step 120, device 260-1 is operative or configured to replace the first term in the first file with a second term found in searching a second list of words to form a modified first file, the second term associated with the first term, wherein the second list of words is associated with the selected first rating level. For example, if device 260-1 is set to, for example, rating level G and if a term, such as “Damn it” 572 in FIG. 5 in the default (the first) list 510 is found in the first original file or web content (the first file), a determination is made to see if a corresponding replacement term is found in the second (or replacement) list 520. If an associated entry such as “Darn” 575 exists in the replacement list 520, then that associated word or phrase will be used as the replacement for the term “Damn it” 572. In one embodiment, the replacement list 520 may also be pre-generated appropriately according to its assigned rating level.

At step 130, the modified file or content is displayed on a screen of user device 260-1. This is illustrated, e.g., in FIG. 4, where the term “Damn it” 320 in the original file or content as shown in FIG. 3 is replaced with the term “Darn” 420 in the modified file or content as shown in FIG. 4.

In one embodiment, all terms in the first list is searched in the first file and all found terms are replaced corresponding terms in the second list before the modified first file is formed.

In one embodiment, after the modified first file is displayed, the user changes the rating level of device 260-1, for example, by selecting a second rating level different from the selected first rating level. After the change, the processing, replacing, and displaying steps are repeated. Since the selected second rating level is different from the selected first rating level, the modified first file for the selected second rating level should be different from the modified file for the selected first rating level. In order to change the rating level, the user may have to enter a correct password. This password should be controlled by an administrator such as a parent and can be modified only by the administrator. Like the first and second list, the third and fourth lists may be user modifiable. It is noted that the original first file whether stored locally in device 260-1 or remotely in a server is not modified and the modified first file can be stored locally in a non-transitory storage but preferably not stored in a non-transitory storage to save the local storage space.

In one exemplary embodiment, as shown at step 140, a user may modify either the default list 510 or replacement list 520, and/or any of the other respective lists for each of the rating levels, to create his or her customized lists. As shown in FIG. 5, one exemplary way of modifying these lists is to select “Edit” function 590 and then select, change and/or or delete the terms shown in lists 510, 520, 530 and 540, using one or more of the user I/O devices 280 shown in FIG. 2. One skilled in the art may readily appreciate that other editing implementations may also be used to edit the lists, as well known in the art. In another embodiment, an administrator or a primary user, such as a parent, can create and/or modify the lists for each user.

In another exemplary embodiment as shown in FIG. 5, if a user has selected the rating level G, and the file or web content contains the term “Ass” as listed in list 510, but no corresponding term is found in associated replacement list 520, i.e., the corresponding term is a blank or not present, then the word “Ass” will be masked or blocked out as shown, e.g., in 430 of FIG. 4. This blocking/masking feature may also be a user selectable option such that all the words found in list 510 are masked or blocked out, regardless of whether corresponding replacement words or phrases may be found in the associated replacement list 520.

In another embodiment, a user specifies the masking color by entering a non-printable binary code when no corresponding term is entered. For example, by entering hex numbers 00, 01, 02, and 03 to represent colors black, red, blue, and green, respectively. In this embodiment, the corresponding entry in the lists in FIG. 5 displays the mask with the specified color. In yet another embodiment, a user can specify a color for a corresponding term in the second list and the corresponding term is displayed in the modified first file with the specified color.

As show in FIG. 4, one exemplary embodiment according to the principles of the present invention may be that each time a word or a phrase in the original file or content is replaced, masked, blocked, or otherwise modified, a pop up notification (e.g., 425 or 435) is displayed to notify the user. In another embodiment, the user points to a replacement term or a mask using, for example, a pointer, in order to invoke the pop up notification for that replacement term or mask. In addition, at step 150 and as illustrated in FIG. 4, the above notification may contain a prompt for a user to enter a password to override the masking, blocking, replacing and/or other modification of the term, so that the original word, phrase, file and/or content may be displayed instead, once the entered password is validated.

In another embodiment, a replacement term (the second term) is displayed with different visual characteristic from the original text, for example, with a different size, font, or color.

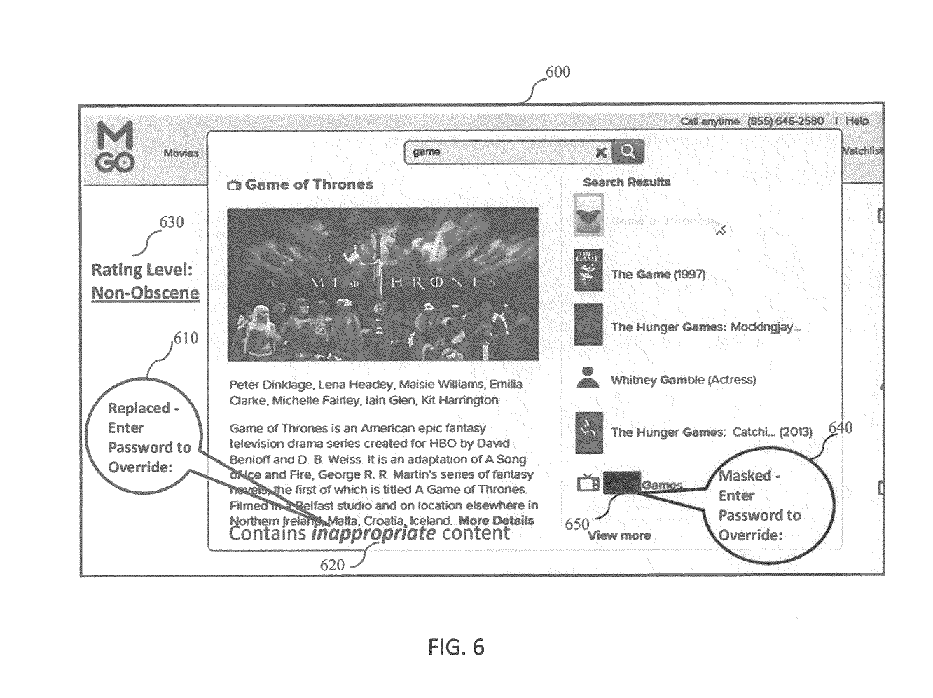

FIG. 6 shows an exemplary display of a web page 600 according to the principles of the present invention. FIG. 6 is an example of a web page 600 displaying a result of a search query on a website for providing different media contents such as movies, television shows, songs, e-books, and etc. As seen from a pop up notification icon 610, the term “inappropriate” 620 is a replacement term for some other original term, where the replacement is according to the selected rating level “Non-Obscene” 630. Likewise, according to a notification 640, a word or a phrase 650 from the original web content has been masked out, also corresponding to the selected rating level “Non-Obscene” 630.

Additional exemplary features according to the principles of the present invention may also be implemented. For example, words can be read in and identified their usage in context—by looking at the words in the vicinity of the suspected word. This allows smarter replacement of phrases or words. Further, a priority weighting as well as grammatical context may be applied to certain words in phrases (e.g., happy and gay would be found as okay for a religious Christian, as would a name for a person). Furthermore, removal of videos, pictures, and other media contents in addition to words and phrases in electronic books, articles or web pages are also contemplated according to the principles of the present invention.

Also as shown in, e.g., FIG. 5, a rating level may be selected for different user profiles of an electronic device such that a child such as, e.g., Joe 595 may have a more restricted rating (e.g., G) and the associated default lists may be generated and/or customized accordingly. On the other hand, Joe's adult parents may have a less restricted rating level, e.g., R (not shown).

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiments.

1. A method for displaying a file in an electronic device, the method comprising:
receiving a first user input for selecting a first rating level of a plurality of rating levels associated with the electronic device;
processing a first file containing a plurality of words by searching for a first term in the first file according to a first list of words, the first list of words associated with the selected first rating level, the first list of words being modifiable by a user;
replacing the first term in the first file with a second term found in searching a second list of words to form a modified first file, the second term associated with the first term, wherein the second list of words is associated with the selected first rating level; and
displaying the modified first file.

2. The method of claim 1 wherein the second list of words being modifiable by the user.

3. The method of claim 2 wherein the first term comprising one of: 1) a word, and 2) a phrase containing more than one words.

4. The method of claim 3 wherein the second term comprising one of: 1) a word, 2) a phrase containing more than one word, and 3) a blank.

5. The method of claim 4 wherein the corresponding second term is selected based on usage context of the first term in the first file.

6. The method of claim 4 further comprising:
receiving a second user input for selecting a second rating level of the plurality of rating levels associated with the electronic device;
processing the first file containing the plurality of words by searching for a third term in the first file according to a third list of words, the third list of words associated with the selected second rating level;
replacing the third term in the first file with a fourth term found in searching a fourth list of words to form another modified first file, the fourth term associated with the third term, wherein a fourth list of words is associated with the selected second rating level; and
displaying the another modified first file.

7. The method of claim 6, wherein the third list of words and the fourth list of words being modifiable by the user.

8. The method of claim 3, wherein the first list of words includes a third term which is associated with no term in the second list of words, the method further comprises:
searching for the third term in the first file; and
masking out the occurrence of the third term in the first file when found.

9. The method of claim 1, further comprising
receiving a password and if the password is correct, voiding the
replacing step and displaying the first term instead of the
corresponding second term.

10. The method of claim 1 where the electronic device is an electronic reader and the first file comprising an electronic book.

11. The method of claim 1 where the first file comprising a web page content.

12. The method of claim 1 wherein the plurality of user rating levels are associated with a specific user profile of the electronic device.

13. The method of claim 1 wherein the plurality of user rating levels are based on one of the following types: 1) movie parental guide rating, 2) television parental guide rating, 3) ratings reflecting level of obscenity, and rating reflecting religious beliefs.

14. An apparatus comprising:
an interface for receiving a first user input for selecting a first rating level of a plurality of rating levels associated with an electronic device;
a processor configured to process a first file containing a plurality of words by searching for a first term in the first file according to a first list of words, the first list of words associated with the selected first rating level, wherein the first list of words is modifiable by a user, the processor (265) is configured to replace the first term in the first file with a second term found in searching a second list of words to form a modified first file, the second term is associated with the first term, and the second list of words is associated with the selected first rating level, and; and
a display for displaying the modified first file.

15. The apparatus of claim 14 wherein the second list of words being modifiable by the user.

16. The apparatus of claim 15 wherein the first term comprising one of: 1) a word, and 2) a phrase containing more than one words.

17. The apparatus of claim 15 wherein the second term comprising one of: 1) a word, 2) a phrase containing more than one word, and 3) a blank.

18. The apparatus of claim 17 wherein the corresponding second term is selected based on usage context of the first term in the first file.

19. The apparatus of claim 16, wherein the first list of words includes a third term which is associated with no term in the second list of words wherein the processor searches for the third term in the first file and masks out the occurrence of the third term in the first file when found.

20. The apparatus of claim 14 where in the processor receives a password and if the password is correct, the processor causes the display of the first term instead of the corresponding second term.

21. The apparatus of claim 14 where the electronic device is an electronic reader and the first file comprising an electronic book.

22. The apparatus of claim 14 where the first file comprising a web page content.

23. The apparatus of claim 14 wherein the plurality of user rating levels are associated with a specific user profile of the electronic device.

25. The apparatus of claim 14 wherein the plurality of user rating levels are based on one of the following types: 1) movie parental guide rating, 2) television parental guide rating, 3) ratings reflecting level of obscenity, and rating reflecting religious beliefs.

26. A computer program product stored in a non-transitory computer-readable storage media comprising computer-executable instructions for:
receiving a first user input for selecting a first rating level of a plurality of rating levels associated with the electronic device;
processing a first file containing a plurality of words by searching for a first term in the first file according to a first list of words, the first list of words associated with the selected first rating level, the first list of words being modifiable by a user;
replacing the first term in the first file with a second term found in searching a second list of words to form a modified first file, the second term associated with the first term, wherein the second list of words is associated with the selected first rating level; and
displaying the modified first file.
